(19) United States
(12) Patent Application Publication
(10) Pub. No.: US 2025/0385890 A1
(43) Pub. Date: Dec. 18, 2025

(54) Sensory and Response Machine Learning Modeling

(71) Applicant: Microsoft Technology Licensing, LLC, Redmond, WA (US)

(72) Inventors: Anthony Lawayne FAULDS, Seattle, WA (US); Michael E. ROBERSON, Vienna, VA (US); Peter Joseph MARINO, Seattle, WA (US); Elham REZVANI, Bellevue, WA (US)

(73) Assignee: Microsoft Technology Licensing, LLC, Redmond, WA (US)

(21) Appl. No.: 18/743,312

(22) Filed: Jun. 14, 2024

(51) Int. Cl. H04L 9/40; G06F 8/60; H04L 67/1396

(52) U.S. Cl. CPC H04L 63/0209; G06F 8/60; H04L 67/1396

(57) ABSTRACT

Examples of the present disclosure describe systems and methods for sensory and response modeling in OWT systems. In examples, a payload is received by a sensory machine learning (ML) model implemented within an OWT system. The sensory ML model outputs an indication associated with data within the payload, such as whether the data belongs to one or more object classes or is indicative of anomalous activity. The output of the sensory ML model is provided to a response ML model implemented within the OWT system. The response ML model outputs a determination associated with the payload, such as whether the payload is permitted to egress across a data boundary of the OWT system or the manner in which data in the payload can be used in the one or more computing environments. The payload is then processed in accordance with the determination.

### BACKGROUND

One-way transfer (OWT) systems facilitate the unidirectional transfer of data across one or more data boundaries. The unidirectional nature of the data transfers affords limited feedback opportunities for data transfers, as the sending side of an OWT system typically cannot track data transferred to or receive response data from a receiving side of the OWT system. Due to this lack of feedback opportunities, users deploying software to a computing environment that is across a data boundary of an OWT system are often tasked with installing, training, and/or maintaining the software within the boundaries of that computing environment. As such, deploying software within the boundaries of an OWT system can place a heavy burden on users.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

The present disclosure describes systems and methods for sensory and response modeling in OWT systems. In examples, a payload is received by a sensory machine learning (ML) model implemented within an OWT system. The sensory ML model outputs an indication associated with data within the payload, such as whether the data belongs to one or more object classes or is indicative of anomalous activity. The output of the sensory ML model is provided to a response ML model implemented within the OWT system. The response ML model outputs a determination associated with the payload, such as whether the payload is permitted to egress across a data boundary of the OWT system or the manner in which data in the payload can be used in the one or more computing environments. The payload is then processed in accordance with the determination.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example system for implementing sensory and response ML modeling in an OWT system.

FIG. 2 illustrates an example process flow for executing sensory ML models and response ML models.

FIGS. 3A-3C illustrate example insights provided by sensory ML models discussed herein.

FIG. 4 illustrates a method for executing sensory ML models and response ML models.

FIG. 5 is a is a block diagram illustrating example physical components of a computing device for practicing aspects of the disclosure.

FIG. 6 is a simplified block diagram of an example distributed computing system for practicing aspects of the present disclosure.

### DETAILED DESCRIPTION

One-way transfer (OWT) systems facilitate the unidirectional transfer of data across one or more data boundaries of the OWT systems. An OWT system refers to a computing system in which one or more endpoints are data diodes configured to ensure that data packets can be transferred only unidirectionally through the computing system. An OWT system may be implemented in various secured computing environments, such as sovereign cloud computing environments, air gapped cloud environments, and other high assurance computing environments (e.g., medical computing environments and financial computing environments). In many cases, OWT systems are used to protect a network or endpoints against outbound data transmissions, malicious inbound data transmissions (e.g., viruses and malware), and cyberattacks. As one example, OWT systems facilitate the transfer of data between computing environments having the same or different security levels (e.g., high-security or low-security), where at least one of the computing environments is low-trust with respect to another of the computing environments. For instance, a first computing environment that is high-trust with respect to the devices of the first computing environment and/or with respect to devices of one or more other computing environments may receive data from a second computing environment that is considered to be low-trust by the first computing environment.

In examples, a high-trust environment refers to a system or network where the devices, applications, and users are considered trustworthy, and security measures are in place to establish and maintain that trust. In this type of environment, the devices and/or parties involved, such as devices, software, and users, are often authenticated, authorized, and/or adhere to established security policies and best practices. High-trust environments usually have rigorous access controls, encryption, and monitoring to ensure that trust is maintained and to minimize the risk of unauthorized access, data breaches, or other security incidents. Devices within high-trust environments may be authorized to access or be accessed by other devices based on security techniques that are implemented by the high-trust environments (e.g., unique encryption keys, secrets, or other cryptographical techniques). For instance, the communications transmitted by a high-trust environment may be considered trustworthy by other computing environments or devices based on the high-trust environment (or devices thereof) being included in an allowlist (e.g., a list of approved devices and/or computing environments). Alternatively, the communications transmitted by a high-trust environment may be considered trustworthy based on a password or credential provided with the communications. In some examples, the devices in a high-trust environment do not require authentication to access or be accessed by other devices. A high-trust environment generally does not expose the security techniques implemented by the high-trust environment to other computing environments, which may be considered low-trust or no-trust environments by the high-trust environment.

By contrast, a low-trust or no-trust environment refers to a system or network where the devices, applications, and/or users are not implicitly trusted or where there is a high risk of unauthorized access or malicious activities. Low-trust or no-trust environments may have limited or no security measures in place, or may include or be connected to one or more external or unmanaged devices. Alternatively or additionally, a low-trust or no-trust environment refers to an environment in which the devices are not considered to be secured or trustworthy by other devices within and/or external to the low-trust or no-trust environments. As the security techniques implemented by the high-trust environment are not exposed to low-trust or no-trust environments, low-trust or no-trust environments may not be able to access or communicate with a high-trust environment without performing various authorization and/or authentication steps that need not be performed by devices in high-trust environments. In examples, an OWT system may span or include multiple computing environments that are separated by one or more data boundaries between computing environments of different trust levels and/or security levels.

The data diodes of an OWT system ensure unidirectional data packet transfer through implementation of hardware and/or software components. In one example, a data diode includes a transmit-only network interface card (NIC). A transmit-only NIC transmits data to an endpoint but cannot receive data from the endpoint due to the physical severing of the receive pin on the network controller chip of the transmit-only NIC. The transmit-only NIC may also comprise firmware which sets the link state of the transmit-only NIC to always be “up” (e.g., enabled and/or active). In another example, a data diode implements a standard (e.g., commodity) NIC and a Y-splitter cable. The Y-splitter separates a data transmission signal such that a first cable of the Y-splitter is connected to a receiving device and a second cable of the Y-splitter is directed back to the transmitting device to establish a layer-1 link state. In yet another example, a data diode implements one or more field-programmable gate array (FPGA) devices to ensure a unidirectional dataflow.

Due to the inherent unidirectionality of data transfers in OWT systems, OWT systems afford users limited opportunities to receive feedback for data transferred across the data boundaries of the OWT systems. For example, the sending side of an OWT system typically cannot track data transferred to, or receive response data from, a receiving side of the OWT system. This lack of feedback is especially problematic in software deployment scenarios in which software requiring configuration is deployed across a data boundary into a secure computing environment of the OWT system. As one specific example, a machine learning (ML) model may be deployed into a computing environment of an OWT system to determine whether certain data or types of data (e.g., PII data, etc.) is permitted to egress from that computing environment. Generally, an ML model is trained and adapted based on user feedback. For example, in addition to the training data (e.g., generic and/or user-specific sample data, policies, and rules) used to train an ML model, the ML model may be further trained using user feedback (e.g., data annotations, result confirmations, or result denials) as part of a feedback loop.

In non-OWT systems, a service provider (e.g., an ML model provider or a cloud service provider) is often available to train or adapt (or assist in training or adapting) an ML model in accordance with user requirements of a specific user (e.g., the ML model consumer). However, in OWT system, service providers are typically unable to access data transferred across the data boundaries of the OWT systems (e.g., ML models deployed in computing environments of the OWT systems). Consequently, the burden of training the ML model within the boundary of the OWT system falls on a user (e.g., the ML model consumer), as the user has access to the ML model within the computing environment of the OWT system. However, training an accurate ML model and maintaining the accuracy of that ML model over time may prove to be a daunting, if not unrealistic, task for users. For instance, training and maintaining an ML model is time-consuming, may require large amounts of training data, and may require users to have expert knowledge of ML modelling in order to optimize an ML model.

The present disclosure provides a solution to the above-described obstacles for training and maintaining ML models and/or other software within the boundaries of an OWT system. Embodiments of the present disclosure describe systems and methods for sensory and response modeling in OWT systems. In examples, data packets comprising payloads are received by one more sensory ML models implemented within an OWT system. The payloads may include data such as files, streaming content, data requests, and action performance requests. The payloads may also include metadata associated with data in the payload, such as a data identifier that is assigned on a per-data basis (e.g., per-file or per-data stream) to uniquely identify the data and/or to indicate a type of data in the payload, and a dataflow identifier that is used to identify a policy to be applied to the data during the transfer of the data across one or more boundaries of the OWT system. In some examples, each sensory ML model receives each of the data packets and/or payloads. In other examples, at least one sensory ML model receives only a subset of the data packets and/or payloads provided to the OWT system. For example, a sensory ML model may only receive data packets and/or payloads that is transmitted from particular users or source endpoints or that includes particular types of data or metadata.

In response to receiving the payloads, the sensory ML model(s) evaluates the payloads and outputs an indication of information associated with the payloads, such as object classes detected in the payloads and anomalous activity associated with the payloads. As one example, the output includes a probability or another value (e.g., a numeric or textual value) that data within the payloads belongs to at least one predefined object class the sensory ML model is trained to detect. As another example, the output includes one or more anomalous activities that were detected during or proximate to the time a request for the payload occurred. The output of the sensory ML model(s) is provided to one or more additional sensory ML model(s) and/or to a response ML model implemented within the OWT system. If the output of the sensory ML model(s) is provided to one or more additional sensory ML model(s), the additional sensory ML model(s) further processes the output of the sensory ML model(s) or provides a refined indication of whether the identified data within the payloads belongs to identified object classes. If the output of the sensory ML model(s) is provided to a response ML model, the response ML model evaluates the output of the sensory ML model(s) and outputs an egress determination of whether the payloads provided to the sensory ML model(s) are permitted to egress across a data boundary of the OWT system. The payloads are then processed (e.g., permitted or not permitted to egress from the OWT system) in accordance with the egress determination of the response ML model.

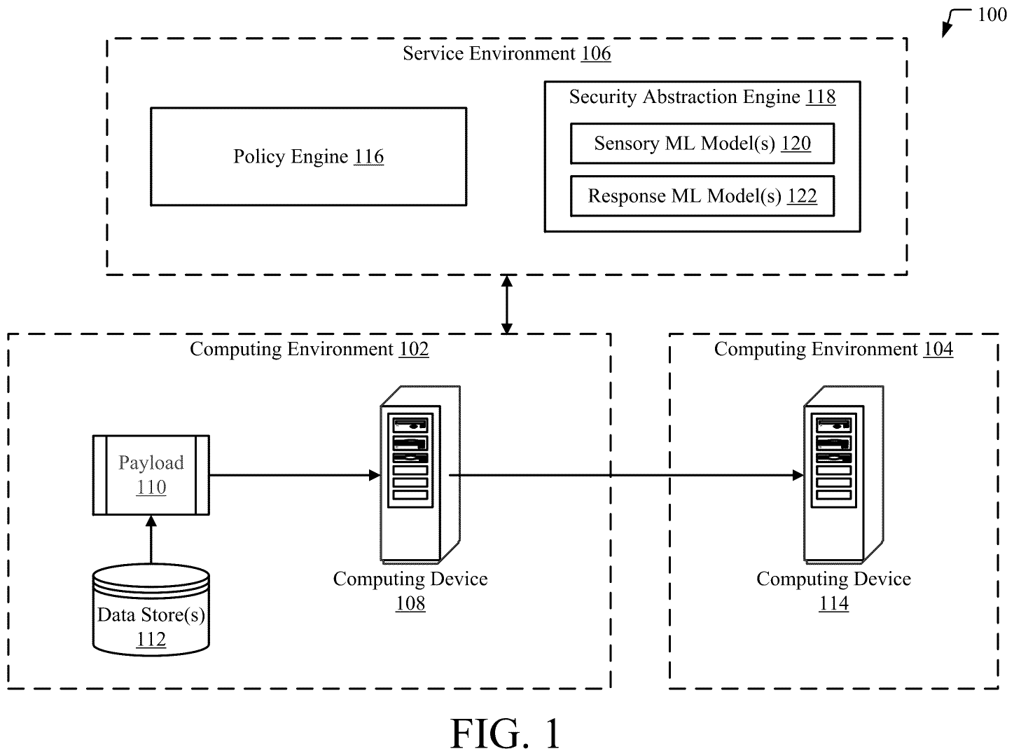

FIG. 1 illustrates an example system for sensory and response modeling in an OWT system. System 100, as presented, is a combination of interdependent components that interact to form an integrated whole. Components of system 100 may be hardware components or software components (e.g., APIs, modules, runtime libraries) implemented on and/or executed by hardware components of system 100. In one example, components of system 100 are distributed across multiple processing devices or computing systems.

In FIG. 1, system 100 represents an OWT system for transmitting data between different computing environments. System 100 comprises computing environments 102 and 104 and service environment 106. In examples, computing environments 102 and 104 are implemented in a cloud computing environment or another type of distributed computing environment and are subject to one or more distributed computing models/services (e.g., Infrastructure as a Service (IaaS), Platform as a Service (PaaS), Software as a Service (SaaS), Functions as a Service (FaaS)). In some examples, service environment 106 is implemented locally in one or more of computing environments 102 and 104. For instance, one or more computing devices in computing environments 102 and/or 104 may each comprise a separate instance of service environment 106. In other examples, service environment 106 is implemented separately from one or more of computing environments 102 and 104. For instance, service environment 106 may be implemented in a cloud computing environment that is remotely accessible by computing environments 102 and/or 104 via a network, such as a private area network (PAN), a local area network (LAN), or a wide area network (WAN).

Although FIG. 1 is depicted as comprising a particular combination of computing environments and devices, the scale and structure of devices and computing environments described herein may vary and may include additional or fewer components than those described in FIG. 1. Further, although examples in FIG. 1 and subsequent figures will be described in the context of OWT systems and data transfers between low-security computing environments and high-security computing environments, the examples are equally applicable to non-OWT systems and data transfers between computing environments of various (or the same) types and security levels. Moreover, the examples are equally applicable to data transfers between components of a single device. For instance, the sensory and/or response models described below may be implemented on a single device having containers (e.g., software data structures for storing data and data objects) with different policies and access privileges to ensure that network traffic received by one of the containers (e.g., a high-security container) cannot be accessed by another of the containers (e.g., a low-security container).

With respect to FIG. 1, computing environment 102 represents a high-security computing environment that is trusted by computing environment 104 (e.g., devices executing within computing environment 102 are trusted by devices executing within computing environment 104). In such examples, computing environment 102 may be physically separated from computing environment 104 such that computing environment 102 is in a first physical location (e.g., region, building, or room) and computing environment 104 is in a different second physical location. Alternatively, computing environment 102 and computing environment 104 may share the same physical location.

Computing environment 102 comprises computing device 108, payload 110, and data store(s) 112. Examples of computing device 108 include data diodes and server devices, such as web servers, file servers, application servers, and database servers. Computing device 108 receives input, such as payload 110, from users, computing devices, or data stores within or accessible to computing environment 102. As one example, payload 110 is received from data store(s) 112. Data store(s) 112 comprise various data items (e.g., documents or files), applications, services, and/or other data resources. Examples of data store(s) 112 include direct-attached storage devices (e.g., hard drives, solid-state drives, and optical disk drives), network-based storage devices (e.g., storage area network (SAN) devices and network-attached storage (NAS) devices), and other types of memory devices. Although data store(s) 112 are depicted in FIG. 1 as being included in computing environment 102, one or more data store(s) 112 may be located external to computing environment 102. Additionally, although data store(s) 112 are depicted in FIG. 1 as being separate from computing device 108, one or more data store(s) 112 may be located within computing device 108.

Payload 110 comprises or requests one or more types of data (e.g., audio data, touch data, text-based data, gesture data, and/or image data), computing instructions (e.g., commands or operations), and/or data items. Alternatively, payload 110 may comprise a completion status (e.g., success, failure, in progress) or an acknowledgement (e.g., request received) of one or more requested actions associated with payload 110. In examples, payload 110 is associated with a transaction identifier that identifies a use case, a transaction, or a source identifier (e.g., an identifier for a user, a computing device, or a component of a computing device) associated with a data request that caused payload 110 to be generated. The transaction identifier is included in (e.g., embedded in or appended to) payload 110.

In examples, computing environment 102 attempts to transmit payload 110 to computing environment 104. For instance, as part of a data egress attempt, computing environment 102 may attempt to transfer payload 110 to a destination endpoint, such as computing environment 104 or a separate computing environment accessible by computing environment 104. In some examples, computing environment 104 represents a low-trust computing environment that considers computing environment 102 to be high-trust. Computing environment 104 comprises computing device 114. Examples of computing device 114 include those devices described above with respect to computing device 108. In some examples, computing device 114 is located proximate to computing device 108 (e.g., in the same building or room). For instance, computing device 114 and computing device 108 may be located in the same room of a data center such that computing device 108 is located in a first data rack (e.g., server rack or data cabinet) and the computing device 114 is located in a second data rack or a different shelf of the first data rack. In such an example, computing device 114 and computing device 108 may be directly connected via point-to-point cabling. In other examples, computing device 114 is located remotely from computing device 108 (e.g., in a different building or room).

As part of the attempt to transmit payload 110 to a destination endpoint (e.g., computing environment 104), computing device 108 accesses service environment 106. In other examples, computing device 108 accesses service environment 106 in response to generating or receiving payload 110. Service environment 106 provides access to various computing services and resources (e.g., applications, devices, storage, processing power, networking, analytics, intelligence). In FIG. 1, service environment 106 comprises at least policy engine 116 and security abstraction engine(s) 118.

Policy engine 116 is a software engine that applies policies to data transmitted using system 100. In examples, policy engine 116 applies a first set of policies to payload 110. Examples of policies in the first set of policies include antivirus scanning policies, watch word detection policies, data hashing policies, digital signature policies, and file type checking and routing policies. Applying the first set of policies includes executing one or more operations associated with the first set of policies on payload 110. Each operation may be a set of executable instructions that is executed by policy engine 116 serially or in parallel with other operations. As one example, policy engine 116 may execute a first operation that causes policy engine 116 to make a call (e.g., request) to a first antivirus service, where the call includes a pointer to the data for which antivirus scanning is to be performed. After (or during) execution of the antivirus scanning by the first antivirus service, policy engine 116 may execute a second operation that causes policy engine 116 to make a call to a second antivirus service. In some examples, policy engine 116 applies additional policies to payload 110 or performs additional processing on payload 110 based on the data identifier for or a file type included within payload 110. For example, policy engine 116 may apply a first type of processing or policies to a first type of file (e.g., a Portable Document Formats (PDF) file) included within payload 110 and apply a second type of processing or policies to a second type of file (e.g., a Joint Photographic Experts Group (JPEG) file) included within payload 110.

In examples, policy engine 116 creates a digital signature for each operation that is successfully executed for payload 110. Creating a digital signature may include applying a cryptographic key to an operation or to the result of an operation. For instance, a cryptography device or service, such as a hardware security module (HSM) or a certificate authority, may use public key cryptography to create a public-private key pair. The private key portion of the public-private key pair may be provided to policy engine 116 and used by policy engine 116 to create a digital signature. If a digital signature is successfully created for each operation associated with the first set of policies, the policy engine 116 provides payload 110 and the set of digital signatures associated with the operations to security abstraction engine 118. For instance, policy engine 116 provides an extensible markup language (XML) manifest comprising the set of digital signatures to security abstraction engine 118 along with payload 110. In at least one example, instead of creating a digital signature for each operation that is executed, policy engine 116 creates a digital signature for each policy that is executed or for the entire first set of policies.

Security abstraction engine 118 is a software engine that abstracts security controls and validates the policies applied to payload 110 by policy engine 116. In examples, security abstraction engine 118 evaluates the digital signatures created by policy engine 116 to determine whether the digital signatures are valid. This evaluation ensures that the operations associated with the first set of policies were executed as expected and that the digital signatures have not been modified during transit from policy engine 116. Evaluating the digital signatures comprises comparing the digital signatures (or attributes of the digital signatures) to expected digital signatures (or expected attributes of the digital signatures) for the first set of policies. For instance, a policy definition for the first set of policies may be stored by (or accessible to) security abstraction engine 118. The policy definition indicates the expected digital signature for each operation executed as part of the first set of policies. Upon receiving the digital signatures for payload 110, security abstraction engine 118 compares the digital signatures for payload 110 to the expected digital signature listed in the policy definition. If a digital signature for payload 110 does not match a corresponding digital signature listed in the policy definition, the non-matching digital signature for payload 110 is determined to be invalid. Upon determining that one or more of the digital signatures for payload 110 are invalid, security abstraction engine 118 may terminate the transfer of payload 110 via system 100 or attempt to perform a corrective action for the data transfer, such as causing a policy or operation to be executed, removing a portion of the data from the data transfer, causing the data to be retransmitted, or providing a notification that one or more digital signatures are invalid to a corrective component of the OWT system.

In some examples, security abstraction engine 118 applies a second set of policies to payload 110. The second set of policies is selected based on the file type(s) or the content of the data in payload 110. In some examples, the second set of policies is regulated based on one or more regulatory authorities (e.g., a government authority or an industry authority). Examples of policies in the second set of policies include code validation policies, content sanitization policies, schema validation policies, and video transcoding policies. In a specific example, the second set of policies includes a schema validation policy that describes and validates the structure and content of XML documents.

Security abstraction engine 118 comprises sensory ML model(s) 120 and response ML model(s) 122. Sensory ML model(s) 120 represent one or computer programs that are conditioned with an algorithm to recognize certain types of patterns and/or to make projections for a set of data, such as data within payload 110. Examples of sensory ML model(s) 120 include decision trees, neural networks, support vector machines, naïve Bayes classifiers, and k-nearest neighbor models. In some examples, sensory ML model(s) 120 are trained (and retrained) outside the boundary of system 100. Some sensory ML model(s) 120 trained outside the system 100 may be further trained on premises of or associated with an entity (e.g., a group, an organization, or a country) by a user associated with the entity (e.g., an administrator, a service provider, or an ML model consumer) using publicly available information. As one example, sensory ML model(s) 120 may be adapted from publicly available, pre-trained models (e.g., open-source ML models, entity-configured ML models, or commercially available ML models) using a general (e.g., user and entity agnostic) set of rules and policies. As a result of using public information and/or pre-trained models, sensory ML model(s) 120 are not specific to any particular user or entity.

In some examples, sensory ML model(s) 120 are trained to detect various occurrences of data. For example, sensory ML model(s) 120 include, but are not limited to credential detection models, country detection models, personally identifiable information (PII) detection models, Internet Protocol (IP) address detection models, and file type detection models. In examples, sensory ML model(s) 120 are trained to detect anomalous activity, such as anomalies in user behavior (e.g., unusual access requests, access times, or access patterns), network behavior (e.g., sudden increases in connection attempts or network usage), and/or data transmitted by system 100 (e.g., embedded scripts or sensitive data). Accordingly, some examples use sensory ML model(s) 120 with behavioral analysis models and data analysis models. In examples, training sensory ML model(s) 120 to detect occurrences of data and anomalous activity comprises providing input to sensory ML model(s) 120 in the form of training data that includes examples of expected inputs and corresponding expected outputs. Training sensory ML model(s) 120 may also comprise establishing or accessing a behavioral baseline (e.g., for a user, a device, or a network) based on historical behavioral data, and providing the behavioral baseline to sensory ML model(s) 120. It is contemplated that a single sensory ML model(s) 120 may be trained to detect various (or all) occurrences of data and anomalous activity, multiple sensory ML model(s) 120 may be trained to detect subsets of various occurrences of data and anomalous activity, each of the sensory ML model(s) 120 may be trained to detect an individual type of occurrence of data or anomalous activity, or some combination thereof.

After sensory ML model(s) 120 are trained outside the boundary of system 100, sensory ML model(s) 120 are transmitted to system 100 and integrated into security abstraction engine 118. For instance, trained sensory ML model(s) 120 are built as part of an API that is implemented by security abstraction engine 118. The API enables sensory ML model(s) 120 to access payload 110. For instance, computing environment 102 may provide payload 110 to sensory ML model(s) 120 using the API or sensory ML model(s) 120 may use the API to retrieve payload 110 from computing environment 102. Alternatively, sensory ML model(s) 120 may access only a subset of the data within payload 110. For instance, data for a first file type within payload 110 is provided to a first sensory ML model 120 and data for a second file type within payload 110 is provided to a second sensory ML model 120. The API may also enable users to interact directly with sensory ML model(s) 120. For instance, a user leverages the API to retrain sensory ML model(s) 120, adjust the parameters (e.g., the weights and coefficients) of sensory ML model(s) 120, or specify the type of sensory ML model(s) 120 to be used for certain types of data flows (e.g., egress data flows and ingress data flows).

Sensory ML model(s) 120 evaluate payload 110 to determine insights for payload 110. An insight, as used herein, refers to facts, projections, or information of relevance derived from data, such as data within payload 110. Examples of insights include determinations of whether payload 110 includes a credential (e.g., a username, a password, a security token, and biometric data), a region identifier (e.g., a country code, a state code, and a city code), PII (e.g., a social security number (SSN), a passport number, a driver's license number, a taxpayer identification number, a patient identification number, and a financial account or credit card number), device information (e.g., an IP address and a media access control (MAC) address), or files of a particular file type (e.g., text files, image files, compressed files). In some examples, insights also include determinations of whether payload 110 includes anomalous data or is indicative of anomalous activity (e.g., by a user, a device, or a network).

Sensory ML model(s) 120 determine insights for payload 110 based on training data used to train sensory ML model(s) 120. As an example, sensory ML model(s) 120 compare the features of data within payload 110 to the features of data (e.g., text content, image content, audio content, or source code content) or the features of a data type (e.g., a file type or a software language type) sensory ML model(s) 120 were trained to detect. A feature refers to an individual measurable property or characteristic of data. Examples of features include the color of pixels, the position (e.g., coordinates) of pixels within data, noise ratios of phenomes, the presence of specific words or characters, the frequency of word usage, the presence of data fields, and the structure or style applied to data. In some examples, comparing the features (e.g., the features in the training data and the features in payload 110) includes invoking additional functionality of sensory ML model(s) 120, or invoking separate sensory ML model(s) 120 or other components of service environment 106. For instance, sensory ML model(s) 120 may also include image processing functionality, such as optical character recognition (OCR), that enables sensory ML model(s) 120 to detect text in an image in order to further enable sensory ML model(s) 120 to determine whether the text in the image is data sensory ML model(s) 120 are trained to detect.

Based on the comparison of the features, sensory ML model(s) 120 generate an insight regarding whether the data in the payload 110 is indicative of data sensory ML model(s) 120 are trained to detect. An insight may be represented as one or more numeric values, text-based values, or a combination thereof. As one example, an insight is represented as a probability or an array of probabilities indicating whether data within payload 110 is a member of one or more object classes. Sensory ML model(s) 120 provide determined insights to response ML model(s) 122. Alternative, sensory ML model(s) 120 provide determined insights to other sensory ML model(s) 120 for additional processing. For instance, a determined insight of a first sensory ML model(s) 120 may be provided as input to a second sensory ML model(s) 120, and the second sensory ML model(s) 120 may refine the determined insight or create an additional insight to be provided to a third sensory ML model(s) 120 or to response ML model(s) 122.

Response ML model(s) 122 represent one or more computer programs conditioned with an algorithm to recognize certain types of patterns and/or to make projections for a set of data, such as insights provided by sensory ML model(s) 120. Examples of response ML model(s) 122 include at least those models discussed above with respect to sensory ML model(s) 120. In examples, response ML model(s) 122 are trained (and retrained) inside the boundary of system 100. For instance, response ML model(s) 122 may be trained within computing environment 102 by a user associated with computing environment 102 (e.g., an administrator of computing environment 102 or an ML model consumer) using user-specific information, entity-specific information, and/or other sensitive information provided by the user. As one example, response ML model(s) 122 is generated within computing environment 102 by a user associated with computing environment 102 and trained using a set of rules and policies that are specific to the user or the entity associated with computing environment 102. As a result of using user-specific or entity-specific information and/or models, sensory ML model(s) 120 are specific to a particular user or entity.

Response ML model(s) 122 may be trained to generate determinations based on insights received from sensory ML model(s) 120. As an example, response ML model(s) 122 include logic for enforcing the rules and policies governing the ingress and/or egress of data, such as payload 110, from system 100 or the usage of data within system 100. In some examples, the logic included within response ML model(s) 122 enables determining whether certain data (e.g., particular combinations of bytes) is permitted ingress to or egress from system 100. In other examples, the logic enables determining whether data associated with certain object classes is permitted ingress to or egress from system 100. For instance, the logic enforces rules and policies governing the ingress or egress of data defined by or relating to object classes such as credentials, IP addresses, project names, and PII.

After response ML model(s) 122 are trained within the boundary of the system 100, response ML model(s) 122 are integrated into security abstraction engine 118. For instance, trained response ML model(s) 122 are built as part of an API that is implemented by security abstraction engine 118. The API may be the same as or different from the API discussed above with respect to sensory ML model(s) 120. The API enables response ML model(s) 122 to access insights provided by sensory ML model(s) 120. For instance, computing environment 102 may provide insights to response ML model(s) 122 using the API or response ML model(s) 122 may use the API to retrieve insights from sensory ML model(s) 120. The API may also enable users to interact directly with response ML model(s) 122. For instance, a user may use the API to retrain response ML model(s) 122 or adjust the parameters (e.g., the weights and coefficients) of response ML model(s) 122. Additionally, a user may use the API to specify actions to be taken based on determinations generated for insights. For instance, a user specifies that, if payload 110 in denied egress from system 100 (or from computing environments 102 or 104), a security action is to be performed, such as quarantining payload 110, executing a data redaction process on payload 110, or notifying a responsible party (e.g. an administrator or a triage group associated with computing environment 102) of the failed egress attempt.

Response ML model(s) 122 evaluates insights generated by sensory ML model(s) 120 to generate determinations for payload 110. As one example, response ML model(s) 122 generates determinations of whether payload 110 is permitted ingress to or egress from system 100 (or from computing environments 102 or 104). In examples, response ML model(s) 122 generate determinations for payload 110 based on training data used to train response ML model(s) 122. For instance, response ML model(s) 122 evaluates the features of data within insights using rules or policies sensory ML model(s) 120 were trained to apply to data transmitted via system 100. In one example, evaluating the features of data within insights comprises comparing values in the data (e.g., values representing a likelihood that the data (or a certain portion of the data) corresponds to a particular object class) to one or more threshold values. For instance, a probability that data belongs to a particular object class is compared to a threshold value to determine whether a payload comprising the data is permitted to egress from system 100. In another example, evaluating the features of data within insights comprises matching character strings in the data to one or more predefined character strings. For instance, a character string indicating one or more particular object classes present in data (e.g., “credential” or “IP address”) is compared (e.g., using pattern matching techniques) to a predefined denylist of character strings corresponding to object classes that are not permitted to egress from system 100. Alternatively, a character string indicating whether any one of a particular set of object classes is present in data (e.g., “yes” or “no”) is compared to a character string in decision logic (e.g., an if-then statement or an alternative Boolean function).

Based on the evaluation of the features of data within insights, response ML model(s) 122 generate a determination for payload 110. In examples, the determination is represented as one or more numeric values, text-based values, or a combination thereof. For instance, a determination indicating that payload 110 is permitted to egress from system 100 may include a value such as “1” or “egress,” whereas a determination indicating that payload 110 is not permitted to egress from system 100 may include a value such as “0” or “no egress.” Alternatively, the determination may be represented as a set of instructions (e.g., a command to egress payload 110), a flag (e.g., one or more data bits used to store binary values), or another type of software signal.

Response ML model(s) 122 provides the determination for payload 110 to security abstraction engine 118. Alternatively, response ML model(s) 122 provide the determination for payload 110 to other response ML model(s) 122 for additional processing. For instance, a determination for payload 110 of a first response ML model(s) 122 is provided as input to a second response ML model(s) 122, and the second response ML model(s) 122 creates an additional determination for payload 110. As a specific example, if first response ML model(s) 122 provide a first determination for payload 110 based on insights from a first set of sensory ML model(s) 120 and second response ML model(s) 122 provide a second determination for payload 110 based on insights from a second set of sensory ML model(s) 120, the first determination and the second determination are provided to third response ML model(s) 122. The third response ML model(s) 122 then provide a determination for payload 110 based on the first determination and the second determination. For instance, if the first determination indicated that payload 110 is permitted to egress from computing environment 102 and the second determination indicated that payload 110 is not permitted to egress from computing environment 102, the third response ML model(s) 122 may generate a third determination that payload 110 is not permitted to egress from computing environment 102. The third determination for payload 110 is then provided to security abstraction engine 118.

In examples, security abstraction engine 118 processes payload 110 in accordance with the determination from response ML model(s) 122. For instance, based on the determination, security abstraction engine 118 allows payload 110 to egress from computing environment 102 to computing environment 104 or prevents payload 110 from egressing from computing environment 102 to computing environment 104. To prevent payload 110 from egressing from computing environment 102, security abstraction engine 118 may perform a security action or may cause another component of system 100 (e.g., policy engine 116 or another processing component of service environment 106) to perform a security action. For instance, security abstraction engine 118 may cause payload 110 to be quarantined or deleted, a data redaction or data removal process to be executed for payload 110, or a responsible party to be notified about the egress determination for payload 110. In instances in which a data redaction or data removal process is executed, a redacted or partial payload 110 may be permitted to egress from computing environment 102.

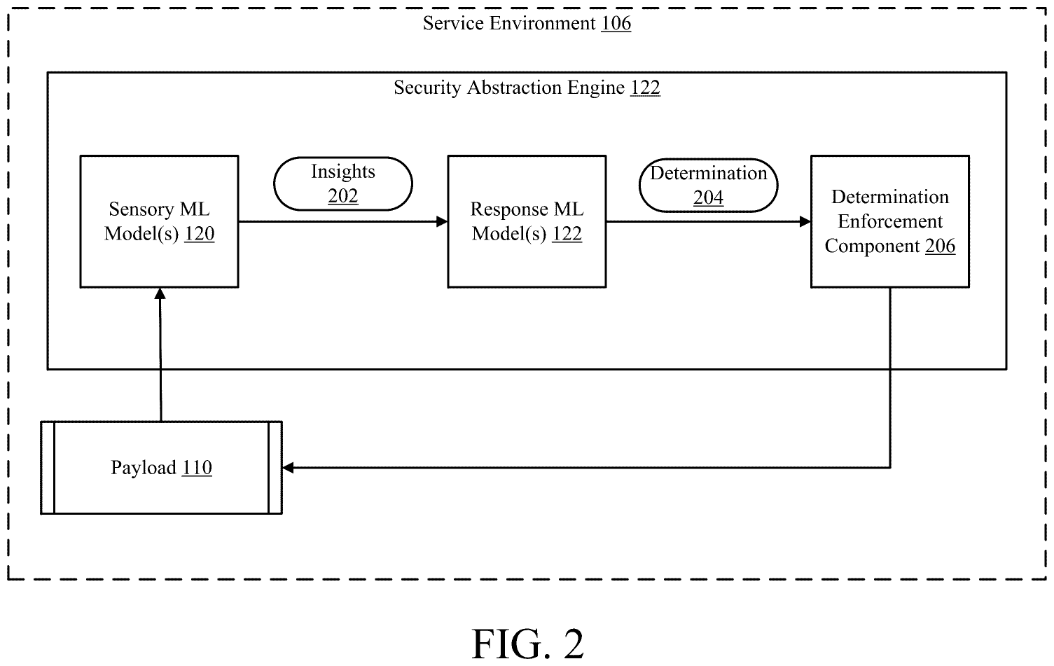

FIG. 2 illustrates an example process flow for executing sensory and response ML models using security abstraction engine 118 of FIG. 1. In process flow 200, sensory ML model(s) 120 receive payload 110 from, for example, computing environment 102. In some examples, each sensory ML model(s) 120 receives and processes at least a portion of payload 110. In other examples, only a subset of sensory ML model(s) 120 receive payload 110. For instance, based on a determined data transfer use case or a dataflow type (e.g., an ingress dataflow or an egress dataflow), payload 110 is provided to a subset of sensory ML model(s) 120 that can be used to process payloads relating to the determined data transfer use case or the dataflow type. As a specific example, if a user associated with a computing environment has specified a policy that PII and project names are not permitted to egress from the computing environment, payloads attempting egress from the computing environment are provided to a first sensory ML model(s) 120 configured to detect PII in payloads and to a second sensory ML model(s) 120 configured to detect project names in payloads. However, payloads attempting egress from the computing environment are not provided to a third sensory ML model(s) 120 configured to detect IP addresses in payloads.

In examples, sensory ML model(s) 120 receive (e.g., are provided or retrieve) payload 110 via an API (or another type of interface) exposed by or to security abstraction engine 118. For instance, sensory ML model(s) 120 and/or response ML model(s) 122 may be built as part of an API that is implemented by security abstraction engine 118, and may receive data (e.g., payload 110 and insights 202) via the API. Upon receiving payload 110, sensory ML model(s) 120 evaluate payload 110 to determine insights 202 for payload 110. In some examples, as part of the evaluation, sensory ML model(s) 120 perform one or more pre-processing operations, such as data conversion (e.g., speech-to-text or image-to-text), data formatting (e.g., ensuring the data is formatted in accordance with a particular schema), text translation (e.g., translating text from a first language to a second language), OCR, image formatting (e.g., modifying aspect ratio, frame rate, color, and other attributes of the video content), and audio formatting (e.g., normalizing audio and removing noise). Alternatively, sensory ML model(s) 120 may invoke one or more pre-processing utilities accessible to security abstraction engine 118 (e.g., utilities implemented within or outside of service environment 106).

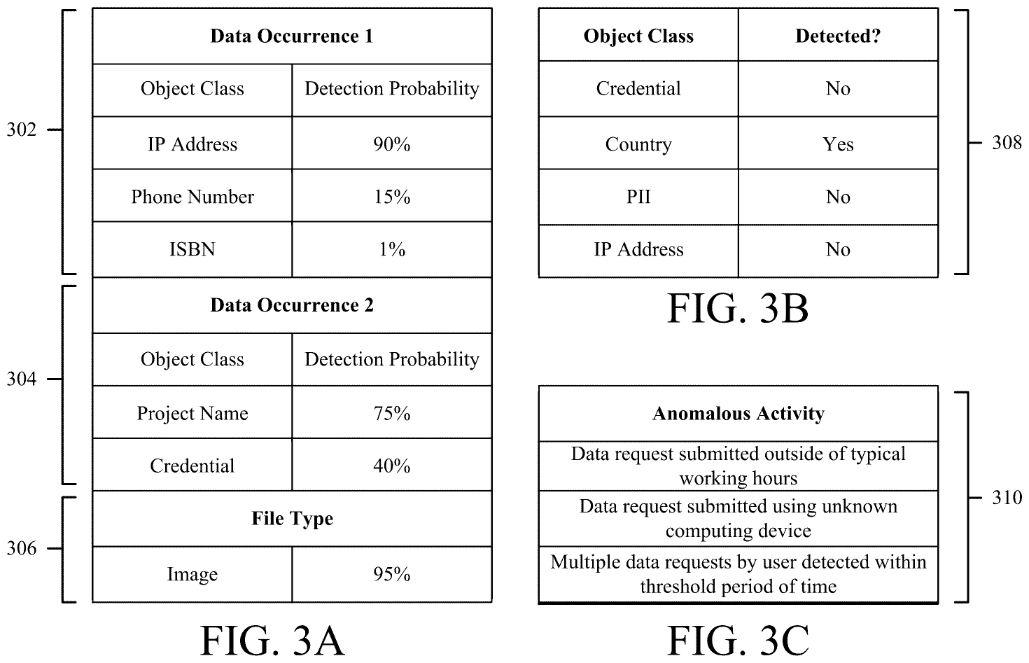

After (or in lieu of) the performance of pre-processing operations, sensory ML model(s) 120 determine insights 202 for payload 110. In examples, determining insights 202 includes using pattern matching techniques (e.g., textual pattern matching algorithms, visual pattern matching algorithms, or audio pattern matching algorithms) to match data in payload 110 to data sensory ML model(s) 120 are trained to detect. Insights 202 may be represented in any of several forms (e.g., as structured data or unstructured data) and comprise various data. As one example, as illustrated in FIG. 3A (discussed below), insights 202 may be represented as a data structure (e.g., tables, arrays, or hashes) comprising probabilities of whether data within payload 110 belongs to one or more object classes. As another example, as illustrated in FIG. 3B (discussed below), insights 202 may be represented as a data structure comprising a list of object classes that are not permitted to egress from a computing environment (e.g., computing environment 102) and indications of whether data within payload 110 corresponds to any of the listed object classes. As yet another example, as illustrated in FIG. 3C (discussed below), insights 202 may be represented as a data structure comprising a list of anomalous activities associated with payload 110. In some examples, insights 202 also include the data upon which insights 202 are based (e.g., the specific data strings, image objects, or audio segments), which may be used to evaluate sensory ML model(s) 120. For instance, as part of retraining or improving sensory ML model(s) 120 over time, users provide feedback to sensory ML model(s) 120 regarding the accuracy of determined insights 202. Sensory ML model(s) 120 use the feedback to adjust one or more parameters of sensory ML model(s) 120, thereby improving the accuracy of determined insights 202.

Insights 202 are provided as input to response ML model(s) 122. Response ML model(s) 122 evaluate insights 202 to generate determination 204 for payload 110. For instance, determination 204 may indicate whether payload 110 is permitted to ingress to or egress from a particular computing environment or whether payload 110 is permitted to be executed or stored within a particular computing environment. In examples, generating determination 204 comprises applying decision logic to insights 202. As one example, in response to receiving insights 202 comprising probabilities of whether data within payload 110 belongs to one or more object classes, response ML model(s) 122 compares each of the probabilities to a threshold value. Threshold values may be stored by (or be otherwise accessible to) security abstraction engine 118. In some instances, the probabilities for each object class are compared against a single threshold value (e.g., 75%). In other instances, the probabilities for each object class are compared against a respective threshold value for the object class (e.g., an IP address threshold value of 70% and a project name threshold value of 85%) or for a subset of object classes (e.g., an IP address and a project name threshold value of 85% and a credential an PII threshold value of 70%). In instances in which there is a respective threshold value for each object class or for different subsets of the object classes, the variance in the threshold values may be due to known difficulties with accurately determining whether data belongs to certain object classes or to the importance of ensuring that data belonging to certain object classes is detected.

In some instances, threshold values are predefined as static values (e.g., defined by a developer during software development or defined by an administrator during software configuration). In other instances, threshold values are adjusted dynamically. For instance, in response to user feedback indicating whether data within payload 110 belongs to an object class assigned by response ML model(s) 122, the threshold values may be adjusted accordingly (e.g., by response ML model(s) 122 or security abstraction engine 118). If a probability satisfies (e.g., meets or exceeds) the threshold value, response ML model(s) 122 assign the corresponding object class to the data. Response ML model(s) 122 then determine whether any of the assigned object classes are those that response ML model(s) 122 are trained to detect, and generate determination 204 for payload 110 accordingly.

As another example of applying decision logic to insights 202, in response to receiving insights 202 comprising a list of anomalous activities associated with payload 110, response ML model(s) 122 use detection techniques to compare text of anomalous activities in insights 202 to text in predefined anomalous activities (e.g., text in a stored list of anomalous activities or anomalous activities response ML model(s) 122 are trained to detect). If text of an anomalous activity in insights 202 matches text in the predefined anomalous activities, response ML model(s) 122 generate determination 204 for payload 110 accordingly. In some instances, the ML-based detection is used to determine whether any anomalous activities in insights 202 match a particular activity in the predefined anomalous activities. In other instances, the ML-based detection is used to determine whether a predetermined minimum number of anomalous activities in insights 202 (e.g., one or three) match corresponding activities in the predefined anomalous activities. In yet other instances, each of the predefined anomalous activities are assigned a predefined weight (e.g., defined by a developer or an administrator) indicating an importance of the activity to determination 204. For each of the anomalous activities in insights 202 that matches one of the predefined anomalous activities, response ML model(s) 122 assign the predefined weight for the predefined anomalous activity to the corresponding activity in the anomalous activities in insights 202. Response ML model(s) 122 combine the weights assigned to the anomalous activities in insights 202 to create a total weight. Response ML model(s) 122 then compare the total weight to a threshold weight value and generate determination 204 for payload 110 accordingly. In examples, determination 204 is represented in any of several forms, such as a numeric value, a text-based value, a set of instructions, or a flag.

Determination 204 is provided as input to determination enforcement component 206. Determination enforcement component 206 is a hardware or software mechanism that enforces determination 204 on payload 110. As one example, if determination 204 indicates that payload 110 is permitted to egress from a particular computing environment, determination enforcement component 206 may transmit payload 110 across a data boundary of the particular computing environment or include an indication (e.g., a flag or other metadata) within payload 110 indicating that payload 110 is permitted to egress across the data boundary. Alternatively, if determination 204 indicates that payload 110 is not permitted to egress from a particular computing environment, determination enforcement component 206 may perform a security action to prevent payload 110 from being transmitted across a data boundary of the particular computing environment (e.g., quarantine or delete payload 110) or include an indication within payload 110 indicating that payload 110 is not permitted to egress across the data boundary.

FIGS. 3A-3C illustrate example insights provided by the sensory ML model(s) discussed herein. FIG. 3A illustrates insights comprising probabilities of whether data within a payload, such as payload 110, belongs to a particular object class or is included in a file of a particular file type. In FIG. 3A, section 302 comprises information relating to an occurrence of first data (e.g., a first character string) in a payload. The information includes the object classes to which a sensory ML model has determined the first data may belong (i.e. IP Address, Phone Number, and ISBN) and the corresponding probabilities that the first data belongs to the determined object classes (i.e. 90%, 15%, and 1%). Section 304 comprises information relating to an occurrence of second data (e.g., a second character string) in the payload. The information includes the object classes to which the sensory ML model has determined the second data may belong (i.e. Project Name and Credential) and the corresponding probabilities that the second data belongs to the determined object classes (i.e. 75% and 40%). Section 306 comprises information relating to a file comprising the first data and the second data. The information includes the file type the sensory ML model has determined for the file (i.e., Image file) and the probability that the file is of the determined file type (i.e., 95%).

FIG. 3B illustrates insights comprising determinations of whether data within a payload, such as payload 110, belongs to one or more object classes. In FIG. 3B, section 308 comprises information relating to a set of enumerated object classes the response ML model(s) 122 discussed herein evaluate to generate determination for payloads. The information includes a list of object classes (i.e., Credential, Country, PII, and IP Address) and a determination of whether a sensory ML model detected each of the object classes in the payload (i.e., only the Country object class was detected).

FIG. 3C illustrates insights comprising anomalous activities associated with a payload, such as payload 110. In examples, the anomalous activities correspond to activity occurring during or associated with a data transfer request that caused a payload to be received by a response ML model. For instance, the anomalous activities may correspond to user or network behavior that was recorded by or provided to a computing environment comprising the response ML model in response to the initiation of a data transfer. In FIG. 3C, section 310 comprises detected anomalous activities (i.e., “Data request submitted outside of typical working hours,” “Data request submitted using unknown computing device,” and “Multiple data requests by user detected within threshold period of time”).

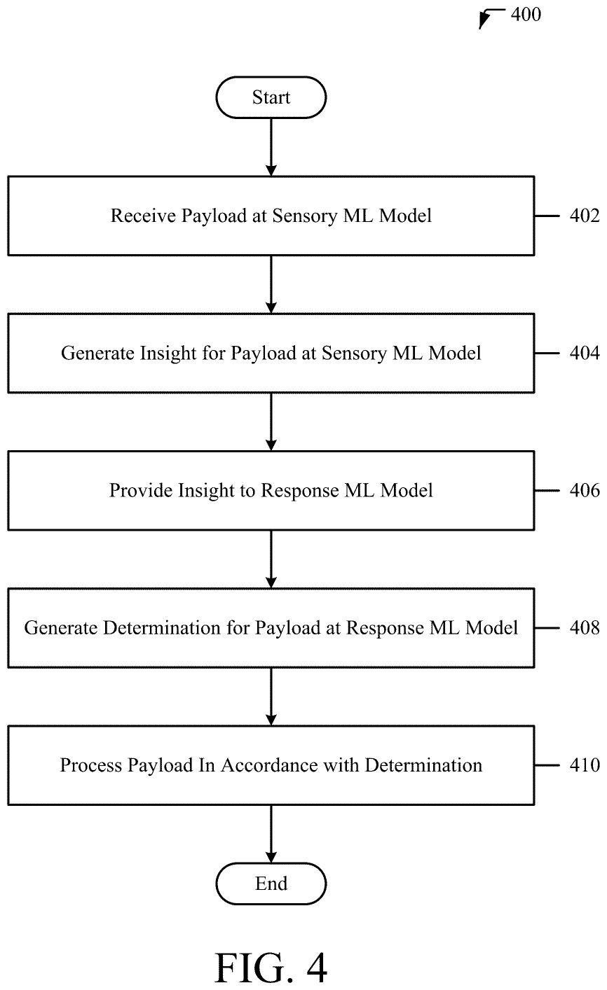

FIG. 4 illustrates a method 400 for executing sensory ML models and response ML models. In examples, method 400 is performed by one or more components of system 100 and/or process flow 200, such as security abstraction engine(s) 118. Accordingly, method 400 is described in the context of system 100 of FIG. 1 and process flow 200 of FIG. 2. However, the performance of method 400 is not limited to such examples.

Method 400 begins at operation 402, where payload 110 is received by sensory ML model(s) 120. In examples, payload 110 is provided to sensory ML model(s) 120 as part of a data transfer request. For instance, the data transfer request may request that payload 110 be transmitted from computing environment 102 to computing environment 104. To determine whether payload 110 is permitted to egress from a particular computing environment, at least a portion of payload 110 is provided to sensory ML model(s) 120 (e.g. by the particular computing environment). For instance, a first sensory ML model(s) 120 or a separate data analysis component of security abstraction engine(s) 118 preprocesses payload 110 using data analysis techniques, such as data classification, data extraction (e.g., keyword extraction and entity recognition), topic analysis, collocation, object detection, and sound detection. Preprocessing payload 110 identifies information such as the number and the file type of files included in payload 110, the types of data included in payload 110 (e.g., text data, image data, and audio data), and the topics related to the data included in payload 110. Based on the preprocessing, a portion of payload 110 is then provided to sensory ML model(s) 120 that are configured to process the data in the portion of payload 110. As a specific example, an image identified in payload 110 is provided to a first sensory ML model(s) 120 configured to identify particular objects in image content and text identified in payload 110 is provided to a second sensory ML model(s) 120 configured to identify particular character strings in text content.

At operation 404, sensory ML model(s) 120 generate insights 202 for payload 110. In examples, insights 202 indicate whether (or a likelihood that) payload 110 includes data related to certain object classes, files of a certain file type, or certain anomalous events, among other things. Insights 202 are represented in any of several forms and comprise various data. For instance, as illustrated in FIGS. 3A-3C, insights 202 may be represented as structured data comprising object class names, file type classifications, detection probabilities or determinations, anomalous activities, and/or the data upon which the insights are based (e.g., character strings, image data, audio data, and file metadata). Alternatively, insights 202 may be represented as unstructured data, such as images, audio, or text-based reports (e.g., in paragraph form or other unstructured forms).

At operation 406, insights 202 are provided to response ML model(s) 122. Response ML model(s) 122 evaluates insights 202 using rules or policies specific to a particular user or entity. For instance, a user associated with a computing environment that provided payload 110 to sensory ML model(s) 120 (e.g., computing environment 102) uses rules and policies governing the ingress and/or egress of data to/from the computing environment to train response ML model(s) 122 within the boundaries of the computing environment. Additionally or alternatively, response ML model(s) 122 may be trained using rules and policies governing the use of data within one or more computing environments (e.g., computing environment 102 and computing environment 104) or trained using any or types of rules and policies.

At operation 408, response ML model(s) 122 generate determinations 204 for payload 110. In some examples, determinations 204 indicate whether payload 110 (or particular data within payload 110) is permitted ingress to or egress from a computing environment. For instance, determinations 204 may indicate that payload 110 is not permitted to egress from computing environment 102, or that payload 110 is permitted to egress from computing environment 102 to computing environment 104, but payload 110 is not permitted to egress from computing environment 104. Alternatively, determinations 204 may indicate that data in payload 110 relating to particular object classes is not permitted to egress from computing environment 102. Determinations 204 are represented in any of several forms, such as numeric values, text-based values, or a set of instructions. For instance, determinations 204 may include a label (e.g., “Yes” or “No”), authorization information (e.g., a credential for accessing a computing device or a computing environment), or an executable script that facilitates access to a separate computing environment. In one example, determinations 204 include metadata to be applied to payload 110, such as flag or a destination address.

At operation 410, payload 110 is processed in accordance with determinations 204. In examples, determinations 204 for payload 110 are provided to determination enforcement component 206, which enforces determinations 204 on payload 110. For example, based on determinations 204, determination enforcement component 206 transmits payload 110 across a data boundary of a computing environment, applies an indication (e.g., a flag or other metadata) associated with determinations 204 to payload 110, or performs (or causes the performance of) one or more security actions. Security actions include quarantining payload 110 (e.g., within service environment 106 or computing environment 102), deleting payload 110, removing data from or redacting data within payload 110 (e.g., removing or redacting data relating to particular object classes), notifying a responsible party of determinations 204, and preventing (e.g., temporarily or indefinitely) subsequent data requests or accesses by particular users or devices (e.g., the user or device that provided or requested payload 110). In some examples, instead of providing determinations 204 to determination enforcement component 206, response ML model(s) 122 enforces determinations 204. For instance, the response ML model(s) 122 used to generate determinations 204 enforces determinations 204 on payload 110. Alternatively, the response ML model(s) 122 used to generate determinations 204 provides determinations 204 to a second response ML model(s) 122, which then enforces determinations 204 on payload 110.

As should be appreciated from the foregoing, the technology described by the present disclosure provides multiple technical benefits and solutions to technical problems. For instance, as discussed above, ML models that are implemented within OWT computing environments (and similar sovereign or air-gapped computing environments) must be trained within the data boundaries of the OWT computing environments due to the difficulty or inability of accessing result data (e.g., feedback) from the OWT computing environments. As the ML model provider typically is unable to access the OWT computing environments, a user associated with the OWT computing environments is burdened with training and maintaining the ML models. Training ML models can require vast of amounts of data and an almost expert knowledge of the training process in order to create accurate ML models and to maintain the accuracy of those ML models over time. The technology described by the present disclosure addresses the above problems with ML model training in OWT computing environments by separating an ML model into a sensory ML model and a response ML model. The sensory ML model and the response ML model have different responsibilities and (re) training locations, and the prerequisite knowledge needed to train and maintain the two ML models is different. Specifically, the sensory ML model can be (re) trained outside the boundary of the computing environment by any of several users (e.g., the ML model provider, the computing environment provider, or any other knowledgeable entity) using pretrained ML model templates and substantial amounts of publicly available sensory detection data. The trained sensory ML model is then transmitted to the OWT computing environment to be executed. In contrast, the response ML model is (re) trained within the boundary of the OWT computing environment using a significantly reduced amount of data due to the reduced feature space of the response ML model. For instance, unlike the sensory ML model, which is trained to be a complex and highly parameterized model (e.g., trained using millions, billions, or trillions of parameters), the response ML model can be trained to be comparatively simple and human-readable model, such as a decision tree, using a small amount of decision logic (e.g., tens or hundreds of rules and policies). Additionally, training the response ML model within the boundary of the computing environment ensures that the decision logic of a user or entity is not exposed outside the boundary of the computing environment.

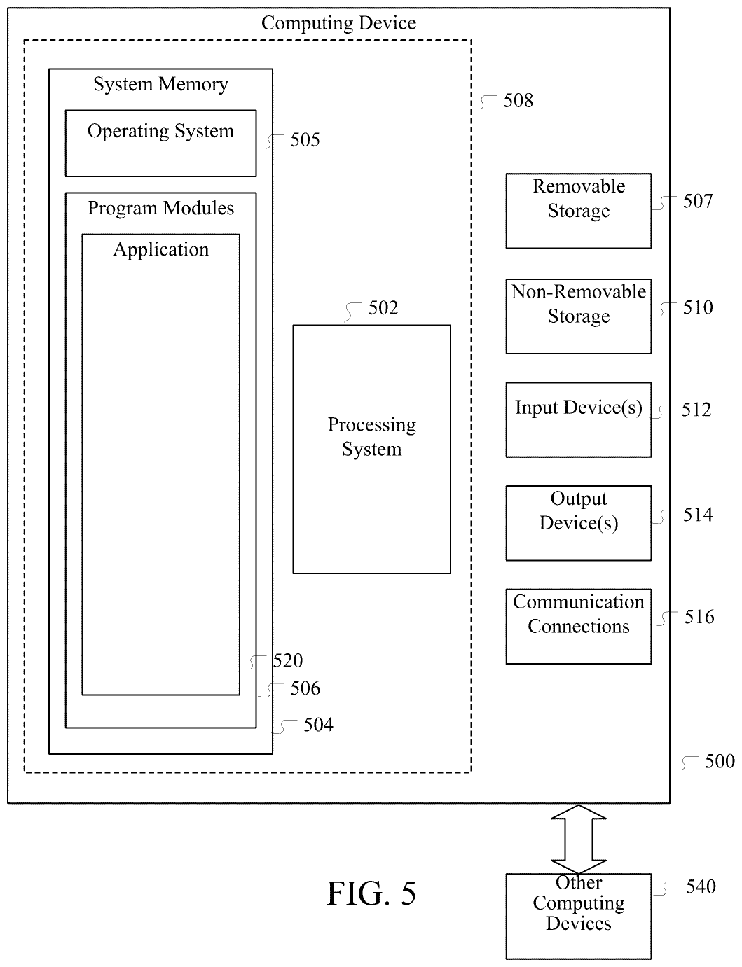

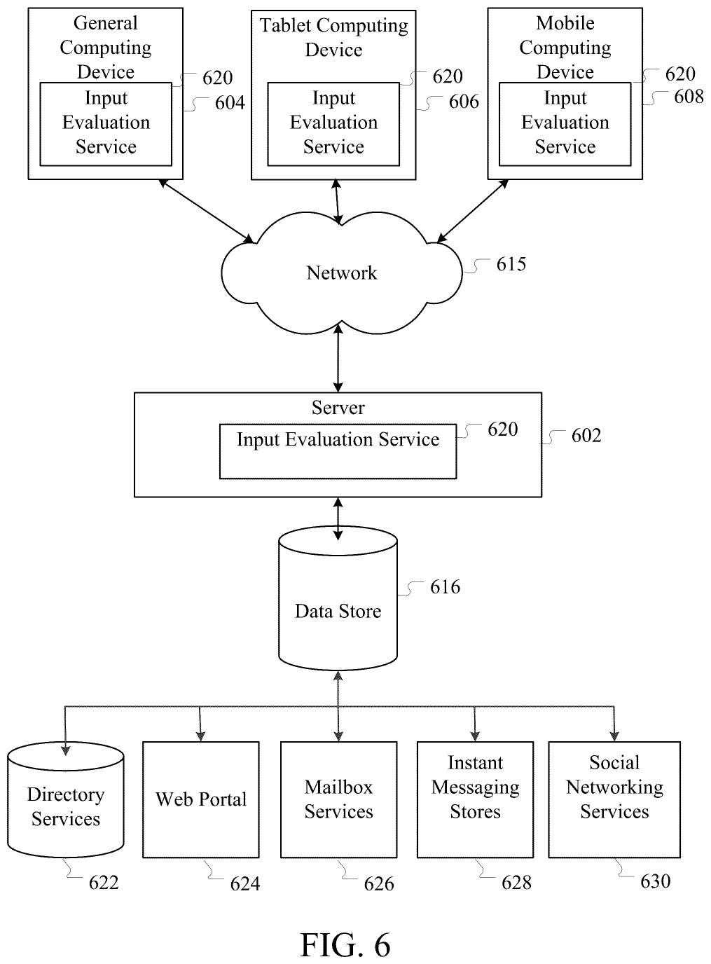

FIGS. 5-6 and the associated descriptions provide a discussion of a variety of operating environments in which aspects of the disclosure may be practiced. However, the devices and systems illustrated and discussed with respect to FIGS. 5-6 are for purposes of example and illustration, and, as is understood, a vast number of computing device configurations may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices and systems described above. In a basic configuration, the computing device 500 includes at least one processing system 502 and a system memory 504. Depending on the configuration and type of computing device, the system memory 504 may comprise volatile storage (e.g., random access memory (RAM)), non-volatile storage (e.g., read-only memory (ROM)), flash memory, or any combination of such memories.

The system memory 504 includes an operating system 505 and one or more program modules 506 suitable for running software application 520, such as one or more components supported by the systems described herein. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, or optical disks. Such additional storage is illustrated in FIG. 5 by a removable storage device 507 and a non-removable storage device 510.

As stated above, a number of program modules and data files may be stored in the system memory 504. While executing on the processing system 502 comprising one or more processors, the program modules 506 (e.g., application 520) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing systems/units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 507, and the non-removable storage device 510 are all computer storage media examples (e.g., memory storage). Computer storage media includes RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 622, a web portal 624, a mailbox service 626, an instant messaging store 628, or a social networking site 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the data store 616, in addition to receiving graphical data useable to be either pre-processed at a graphic-originating system, or post-processed at a receiving computing system.

As will be understood from the present disclosure, one example of the technology discussed herein relates to a system comprising: a processing system; and memory coupled to the processing system, the memory comprising computer executable instructions that, when executed, perform operations comprising: receiving, from a first computing environment, a payload at a sensory machine learning (ML) model implemented in a service environment; generating, using the sensory ML model, an insight for the payload based on data within the payload; providing the insight to a response ML model implemented in the service environment; generating, using the response ML model, an egress determination for the payload based on data within the insight, wherein the egress determination indicates whether the payload is permitted to egress from the first computing environment to a second computing environment; and processing the payload based on the egress determination.

In another example, the technology discussed herein relates to a method comprising: receiving, from a computing environment of a one-way transfer (OWT) system, a payload at a sensory machine learning (ML) model implemented in a service environment of the OWT system; generating, using the sensory ML model, an insight for the payload based on data within the payload; providing the insight to a response ML model implemented in the service environment; generating, using the response ML model, a determination for the payload based on data within the insight, wherein the determination indicates at least one of: whether the payload is permitted to egress from the computing environment; or a permitted use of data within the payload in the computing environment; and processing the payload based on the determination.

In another example, the technology discussed herein relates to a one-way transfer (OWT) system comprising: a processing system; and memory coupled to the processing system, the memory comprising computer executable instructions that, when executed, perform operations comprising: receiving, from a computing environment of the OWT system, a payload at a sensory machine learning (ML) model implemented in a processing engine of the OWT system; generating, using the sensory ML model, an insight for the payload, wherein the insight includes at least one object class corresponding to data in the payload; providing the insight to a response ML model implemented in the processing engine; generating, using the response ML model, a determination for the payload based on the at least one object class, wherein the determination indicates the payload is not permitted to egress from the computing environment; and disallowing the payload to egress from the computing environment based on the determination.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processing system; and
memory comprising computer executable instructions that, when executed, perform operations comprising:
receiving, from a first computing environment, a payload at a sensory machine learning (ML) model implemented in a service environment;
generating, using the sensory ML model, an insight for the payload based on data within the payload;
providing the insight to a response ML model implemented in the service environment;
generating, using the response ML model, an egress determination for the payload based on data within the insight, wherein the egress determination indicates whether the payload is permitted to egress from the first computing environment to a second computing environment; and
processing the payload based on the egress determination.

2. The system of claim 1, wherein the first computing environment and the second computing environment are part of a one-way transfer system.

3. The system of claim 1, wherein the sensory ML model is trained outside of the service environment and the response ML model is trained inside of the service environment.

4. The system of claim 1, wherein the sensory ML model and the response ML model are implemented in a security abstraction engine comprising an application programming interface (API) for interfacing with at least one of the sensory ML model or the response ML model.

5. The system of claim 1, the operations further comprising:
prior to receiving the payload at the sensory ML model, generating a preprocessed payload by preprocessing the payload in the service environment, wherein preprocessing the payload identifies at least one of:
a number of files in the payload;
a file type of at least one file in the payload; or
a topic related to data in the payload.

6. The system of claim 5, wherein:
the sensory ML model is a first sensory ML model; and
the operations further comprise:
providing a first portion of the preprocessed payload to the first sensory ML model; and
providing a second portion of the preprocessed payload to a second sensory ML model implemented in the service environment.

7. The system of claim 1, wherein the insight includes a likelihood that the payload comprises at least one of:
data relating to an object class identified in the payload; or
files of a file type identified in the payload.

8. The system of claim 1, wherein the service environment is implemented at least partly within the first computing environment.

9. The system of claim 1, wherein the insight includes an anomalous activity corresponding to at least one of user behavior or network behavior associated with the payload.

10. The system of claim 1, wherein generating the egress determination for the payload comprises using, by the response ML model, rules or policies specific to a particular user or a particular entity to evaluate the insight.

11. The system of claim 10, wherein the rules or policies govern egress of data from the first computing environment and at least one of:
ingress of data to the first computing environment; or
usage of data within the first computing environment.

12. The system of claim 1, wherein processing the payload comprises:
providing the egress determination to a determination enforcement component implemented in the service environment; and
enforcing, by the determination enforcement component, the egress determination on the payload.

13. The system of claim 12, wherein enforcing the egress determination comprises:
transmitting the payload to the second computing environment; or
applying an indication associated with the egress determination to the payload.

14. The system of claim 12, wherein enforcing the egress determination comprises causing performance of a security action corresponding to:
quarantining the payload;
deleting the payload; or
notifying a responsible party of the egress determination for the payload.

15. A method comprising:
receiving, from a computing environment of a one-way transfer (OWT) system, a payload at a sensory machine learning (ML) model implemented in a service environment of the OWT system;
generating, using the sensory ML model, an insight for the payload based on data within the payload;
providing the insight to a response ML model implemented in the service environment;
generating, using the response ML model, a determination for the payload based on data within the insight, wherein the determination indicates at least one of:
whether the payload is permitted to egress from the computing environment; or
a permitted use of data within the payload in the computing environment; and
processing the payload based on the determination.

16. The method of claim 15, wherein:
the computing environment is a first computing environment; and
the payload is provided to the sensory ML model as part of a data transfer in which the payload is to be transmitted from the first computing environment to a second computing environment of the OWT system.

17. The method of claim 16, wherein the first computing environment is a trusted environment and the second computing environment is an untrusted environment.

18. The method of claim 15, wherein processing the payload comprises:
creating a modified payload by removing or redacting a portion of the payload; and
enabling the modified payload to egress from the computing environment.

19. The method of claim 15, wherein processing the payload comprises:
preventing the payload from egressing from the computing environment; and
preventing subsequent data flows of a user or a device that caused a data flow associated with the payload.

20. A one-way transfer (OWT) system comprising:
a processing system; and
memory comprising computer executable instructions that, when executed, perform operations comprising:
receiving, from a computing environment of the OWT system, a payload at a sensory machine learning (ML) model implemented in a processing engine of the OWT system;
generating, using the sensory ML model, an insight for the payload, wherein the insight includes at least one object class corresponding to data in the payload;
providing the insight to a response ML model implemented in the processing engine;
generating, using the response ML model, a determination for the payload based on the at least one object class, wherein the determination indicates the payload is not permitted to egress from the computing environment; and
disallowing the payload to egress from the computing environment based on the determination.
